(19) United States
(12) Patent Application Publication
(10) Pub. No.: US 2005/0080926 A1
(43) Pub. Date: Apr. 14, 2005

(54) Network address translation in the global system for mobile communications

(76) Inventors: Kejitan Jockey Dontas, Vashi (IN); Gerard Joseph Polfer, Big Rock, IL (US)

Correspondence Address: PATTON BOGGS, 1660 LINCOLN ST, SUITE 2050, DENVER, CO, 80264, US

(21) Appl. No.: 10/674,157

(22) Filed: Sep. 29, 2003

(51) Int. Cl. G06F 15/173; G06F 15/16

(52) U.S. Cl. 709/245

(57) ABSTRACT

The network address translation system in a Global System for Mobile Communications network isolates internal IP traffic from external IP traffic in the Inter-Working Function (IWF) of a Global System for Mobile Communications network by assigning dual IP addresses for the Inter-Working F unction Protocol Engine. The Inter-Working Function Protocol Engine includes one or more Ethernet Ports, each of which is assigned a private IP address, to connect to the Ethernet Switch as well as a public IP address of the customer's network, used to connect to L2TP Network Server.

### FIELD OF THE INVENTION

This invention relates to mobile communication systems and in particular to a system for providing multiple IP addresses to a port in a Global System for Mobile Communications network.

### PROBLEM

It is a problem in the field of mobile communications systems to isolate internal IP traffic from external IP traffic in the Inter-Working Function (IWF) of a Global System for Mobile Communications network. In particular, the Inter-Working Function is used to process both customer-based Internet traffic and Operations, Administration, Maintenance & Provisioning functions. The Operations, Administration, Maintenance & Provisioning functions should not be accessible via a public Internet address while the customer-based Internet presence is accessible via a public Internet address. Existing solutions require the use of both hardware and software in order to provision the Operations, Administration, Maintenance & Provisioning functions. However, each of the existing solutions entail additional cost and complexity to provide the traffic isolation.

### SOLUTION

The above described problems are solved and a technical advance achieved by the present network address translation system in a Global System for Mobile Communications network which isolates internal IP traffic from external IP traffic in the Inter-Working Function (IWF) of a Global System for Mobile Communications network by assigning dual IP addresses for the Inter-Working Function Protocol Engine.

The Inter-Working Function Protocol Engine includes one or more Ethernet Ports, each of which is assigned a private IP address, to connect to the Ethernet Switch as well as a public IP address of the customer's network, used to connect to L2TP Network Server. The customer data received from the Mobile Subscriber Station is passed from the GSM Mobile Switching Controller to the Inter-Working Function Protocol Engine, where it is switched through one or more Ethernet Ports to Ethernet Switch and then to the L2TP Network Server for transmission to the Internet.

Internal IP traffic is transmitted through the Ethernet Switch among the Inter-Working Function Management System, used for Operations, Administration, Maintenance & Provisioning functions, modem pool, and the Inter-Working Function Protocol Engine, using the private IP address assigned to one or more Ethernet Ports of Inter-Working Function Protocol Engine.

### BRIEF DESCRIPTION OF THE DRAWINGS

FIG. 1 illustrates in block diagram form the overall architecture of the present network address translation system that isolates internal IP traffic from external IP traffic in the Inter-Working Function (IWF) of a Global System for Mobile Communications network and an environment in which it is operational;

FIG. 2 illustrates in block diagram form the architecture of an existing wireless network that serves to interconnect customer premise equipment with selected destinations; and

FIGS. 3-5 illustrate in block diagram form the architecture of existing wireless network configurations that isolate internal IP traffic from external IP traffic in the Inter-Working Function (IWF) of a Global System for Mobile Communications network.

### DETAILED DESCRIPTION OF THE DRAWINGS

It is a problem in the field of mobile communications systems to isolate internal IP traffic from external IP traffic in the Inter-Working Function (IWF) of a Global System for Mobile Communications network.

Existing Internet Access Systems

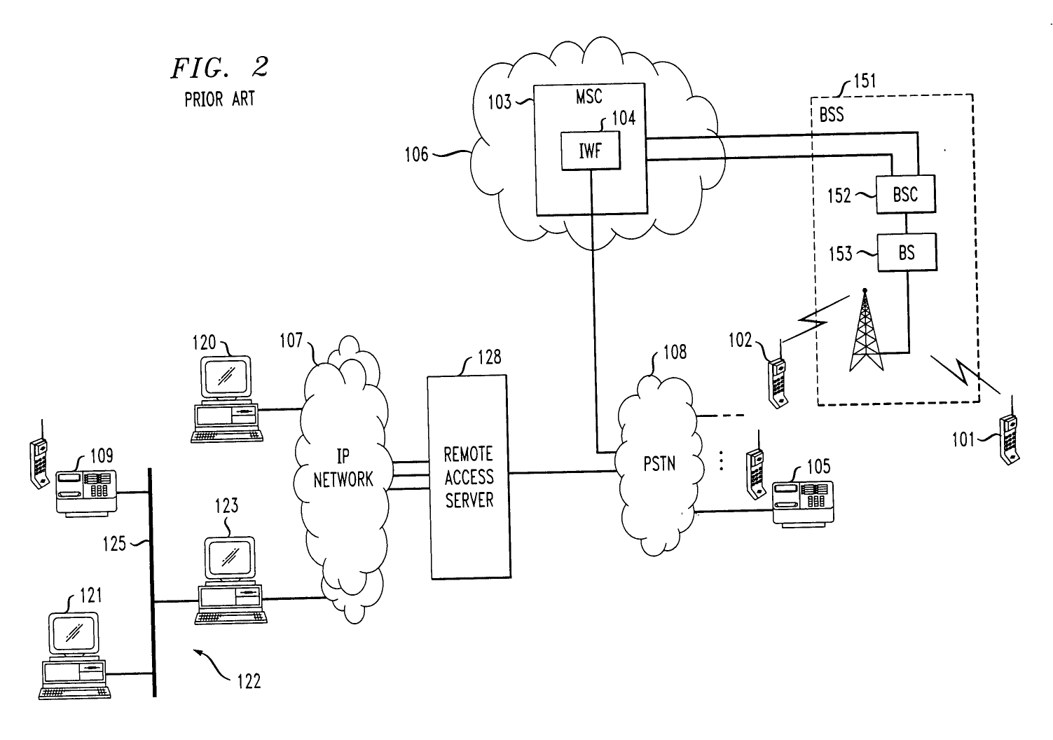

FIG. 2 illustrates in block diagram form the architecture of an existing wireless network that serves to interconnect customer premise equipment with the Internet. Cellular communication networks 106 as shown in block diagram form in FIG. 2 provides the service of connecting wireless telecommunication customers, each having a mobile subscriber station, to both land-based customers 105 who are served by the Public Switched Telephone Network (PSTN) 108 as well as other wireless telecommunication customers 102. In such a network, all incoming and outgoing calls are routed through Mobile Switching Centers (MSC) 103, each of which is connected to a plurality of Base Station Subsystems (BSS) 151 which communicate with mobile subscriber stations 101 located in the area covered by the cell sites. The mobile subscriber stations 101 are served by the Base Station Subsystems (BSS) 151, each of which is located in one cell area of a larger service region. Each cell site in the service region is connected by a group of communication links to the Mobile Switching Center 103. Each cell site contains a group of radio transmitters and receivers, termed a Base Station (BS) 153 herein, with each transmitter-receiver pair being connected to one communication link. Each transmitter-receiver pair operates on a pair of radio frequencies to create a communication channel: one frequency to transmit radio signals to the mobile subscriber station and the other frequency to receive radio signals from the mobile subscriber station. The Mobile Switching Center 103, in conjunction with the Home Location Register (HLR) and the Visitor Location Register (VLR) of the Mobile Switching Center 103, manages subscriber registration, subscriber authentication, and the provision of wireless services such as voice mail, call forwarding, roaming validation and so on. The Mobile Switching Center 103 is connected to an Interworking Function 104 which serves to interconnect the Mobile Switching Center 103 with the Public Switched Telephone Network (PSTN) 108. In addition, the Interworking Function 104 is connected to a Remote Access Server 128 which provides access to the Internet.

The voice communications between mobile subscriber station 101 and other subscriber stations, such as land line based subscriber station 105, is effected by routing the communications received from the mobile subscriber station 101 through the Mobile Switching Center 103 and trunks to the Public Switched Telephone Network (PSTN) 108 where the communications are routed to a Local Exchange Carrier (not shown) that serves land line based subscriber station 105. There are numerous Mobile Switching Centers 103 that are connected to the Public Switched Telephone Network (PSTN) 108 to thereby enable subscribers at both land line based subscriber stations and mobile subscriber stations to communicate between selected stations thereof. Data communications between mobile subscriber station 101 and other data communication systems, such as server 120 or corporate network 122, is effected by routing the data communications received from the mobile subscriber station 101 through Mobile Switching Center 103, Interworking Function 104 and Remote Access Server 128 via an ISUP/ISDN Primary Rate connection. The corporate network 122 typically comprises a corporate gateway server 123, which connects data communications received from the Internet 107 to various servers 121 and terminal devices 109 via an internal Local Area Network 125. This architecture represents the present architecture of the wireless and wire-line communication networks.

In this network architecture, the data communications from mobile subscriber station 101 to the Internet (through an Internet Service Provider) or a corporate network 122 must be switched through the Remote Access Server 128 to the Internet 107. The dial-up access to the corporate gateway 122 through Remote Access Server 128 can be a long distance call to the corporate office. To achieve reasonable data rates, the wire-line connection from the Remote Access Server 128 to the Internet 107 must be a high data rate line with its associated costs, such as an ISUP/ISDN Primary Rate connection.

Existing Network Address Translation Systems

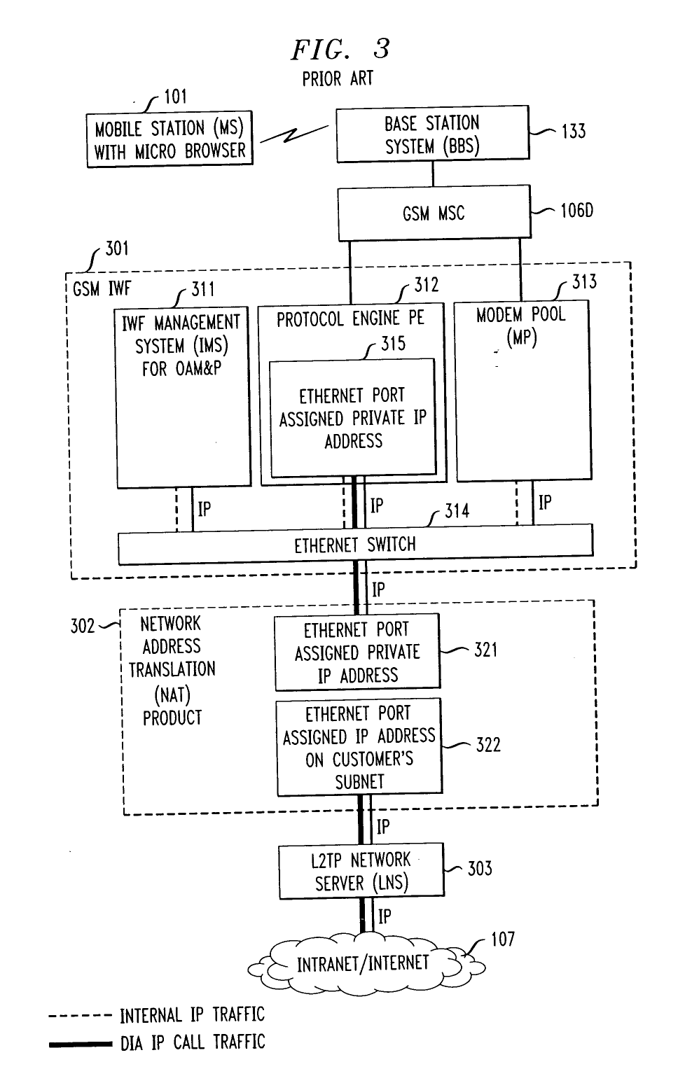

FIGS. 3-5 illustrate in block diagram form the architecture of existing wireless network configurations that isolate internal IP traffic from external IP traffic in the Inter-Working Function (IWF) of a Global System for Mobile Communications network. In particular, the Inter-Working Function is used to process both customer-based Internet traffic and Operations, Administration, Maintenance & Provisioning functions. The Operations, Administration, Maintenance & Provisioning functions should not be accessible via a public Internet address while the customer-based Internet presence is accessible via a public Internet address. Existing systems use both hardware and software to separate the two types of IP traffic within the Inter-Working Function (IWF) of a Global System for Mobile Communications network.

FIG. 3 illustrates the use of a Network Address Translation system 302, connected to the Inter-Working Function (IWF) 301 of a Global System for Mobile Communications network, to isolate internal IP traffic from external IP traffic in the Inter-Working Function (IWF) 301 of a Global System for Mobile Communications network. The Inter-Working Function (IWF) 301 includes an Ethernet Switch 314 that interconnects the Inter-Working Function Management System 311, used for Operations, Administration, Maintenance & Provisioning functions, with the Inter-Working Function Protocol Engine 312 and a modem pool 313. The Inter-Working Function Protocol Engine 312 is also connected by Network Address Translation system 302 to the Internet 107 in well-known fashion via an L2TP Network Server 303. The Network Address Translation system 302 includes one or more Ethernet Ports 321, each of which are assigned a private IP address, to connect to the Ethernet Switch 314. In addition, one or more Ethernet Ports 322, each of which is assigned a public IP address of the customer's network is used to connect to L2TP Network Server 303. Thus, customer data as shown by the heavy solid line on FIG. 3, received from the Mobile Subscriber Station 101 is passed from the GSM Mobile Switching Controller 106D to the Inter-Working Function Protocol Engine 312, where it is switched through Ethernet Switch 314 to one or more Ethernet Ports 321 of the Network Address Translation system 302 to the L2TP Network Server 303 for transmission to the Internet 107.

Internal IP traffic, shown by the dotted line in FIG. 3, is transmitted through the Ethernet Switch 314 among the Inter-Working Function Management System 311, used for Operations, Administration, Maintenance & Provisioning functions, with the Inter-Working Function Protocol Engine 312 and a modem pool 313. Thus, the system of FIG. 3 requires the use of a Network Address translation system 302 to present an Ethernet Port 322 having the IP address of the customer's network to the Internet 107 via an L2TP Network Server 303. This public IP address is translated by the Network Address translation system 302 and the data transferred through the Ethernet Switch 314 to the Mobile Subscriber Station 101. Thus, the internal IP addresses active on the Ethernet Switch 314 are hidden from outside public access, since they reside behind the protection afforded by the Network Address translation system 302.

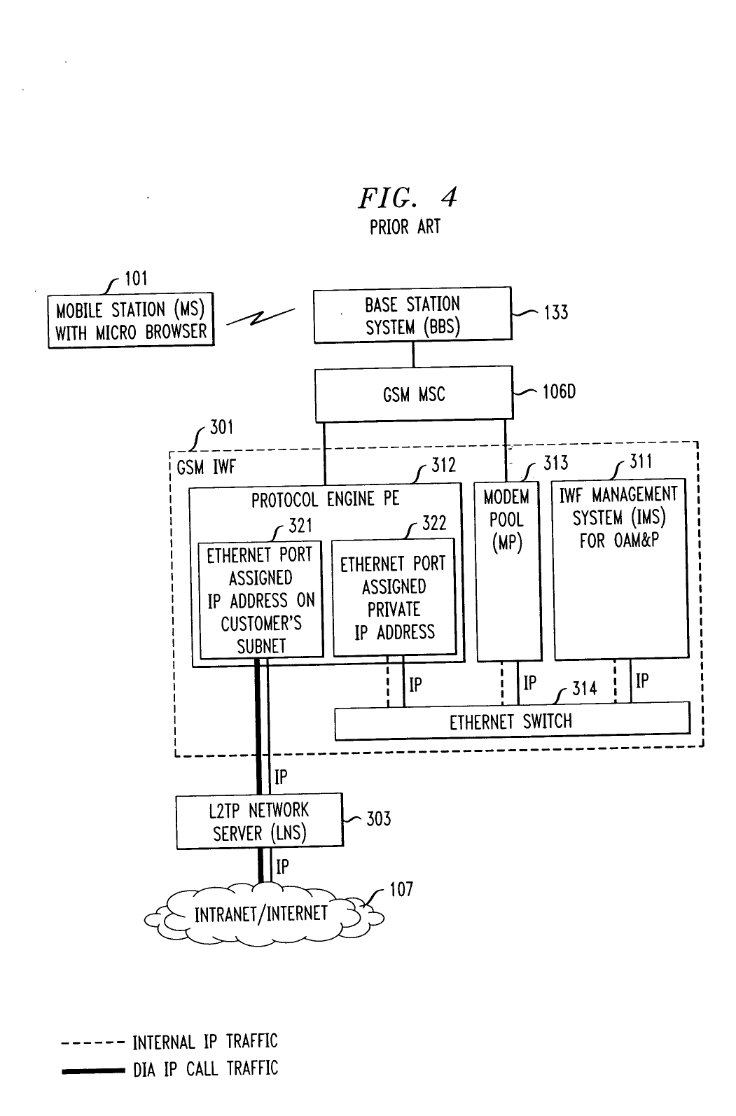

A similar system is shown in FIG. 4, where the Inter-Working Function (IWF) 301 includes a n Ethernet Switch 314 that interconnects the Inter-Working Function Management System 311, used for Operations, Administration, Maintenance & Provisioning functions, with the Inter-Working Function Protocol Engine 312 and a modem pool 313. The Inter-Working Function Protocol Engine 312 is also connected to the Internet 107 in well-known fashion via an L2TP Network Server 303. The Inter-Working Function Protocol Engine 312 includes one or more Ethernet Ports 321, each of which is assigned a public IP address of the customer's network, to connect to the L2TP Network Server 303. In addition, the Inter-Working Function Protocol Engine 312 includes one or more Ethernet Ports 322, each of which is assigned a private IP address to connect to the Ethernet Switch 314. Thus, customer data as shown by the heavy solid line on FIG. 4, received from the Mobile Subscriber Station 101 is passed from the GSM Mobile Switching Controller 106D to the Inter-Working Function Protocol Engine 312, where it is switched through one or more Ethernet Ports 321 to the L2TP Network Server 303 for transmission to the Internet 107.

Internal IP traffic, shown by the dotted line in FIG. 4, is transmitted through the Ethernet Switch 314 among the Inter-Working Function Management System 311, used for Operations, Administration, Maintenance & Provisioning functions, with the Inter-Working Function Protocol Engine 312 and a modem pool 313. Thus, the system of FIG. 4 requires the use of one or more Ethernet Ports 321 to present an Ethernet Port having the IP address of the customer's network to the Internet 107 via an L2TP Network Server 303 in addition to the Ethernet Ports 322 to connect to the Ethernet Switch 314 for internal IP traffic. The public IP address is translated by the presence of one or more Ethernet Ports 321 to present an Ethernet Port having the IP address of the customer's network and the data transferred through the Inter-Working Function Protocol Engine 312 to the Mobile Subscriber Station 101. Thus, the internal IP addresses active on the Ethernet Switch 314 are hidden from outside public access, since they reside behind the protection afforded by the use of the multiple Ethernet Ports in the Inter-Working Function Protocol Engine 312.

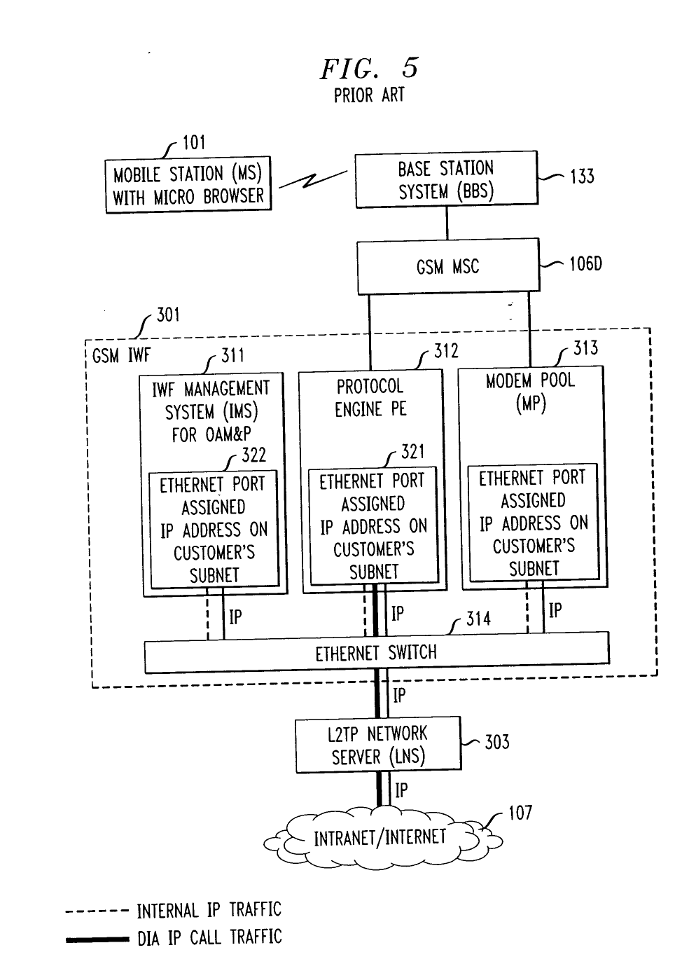

A similar system is shown in FIG. 5, where the Inter-Working Function (IWF) 301 includes an Ethernet Switch 314 that interconnects the Inter-Working Function Management System 311, used for Operations, Administration, Maintenance & Provisioning functions, with the Inter-Working Function Protocol Engine 312 and a modem pool 313. The Ethernet Switch 314 is also connected to the Internet 107 in well-known fashion via an L2TP Network Server 303. The Inter-Working Function Protocol Engine 312 includes one or more Ethernet Ports 321, each of which is assigned a public IP address of the customer's network, to connect to the L2TP Network Server 303 via the Ethernet Switch 314. In addition, the Inter-Working Function Management System 311 includes one or more Ethernet Ports 321, each of which is assigned a public IP address of the customer's network to connect to the Ethernet Switch 314. Thus, customer data as shown by the heavy solid line on FIG. 5, received from the Mobile Subscriber Station 101 is passed from the GSM Mobile Switching Controller 106D to the Inter-Working Function Protocol Engine 312, where it is switched through one or more Ethernet Ports 321 and the Ethernet Switch 314 to the L2TP Network Server 303 for transmission to the Internet 107.

Internal IP traffic, shown by the dotted line in FIG. 5, is transmitted through the Ethernet Switch 314 among the Inter-Working Function Management System 311, used for Operations, Administration, Maintenance & Provisioning functions, with the Inter-Working Function Protocol Engine 312 and a modem pool 313. Thus, the system of FIG. 5 requires the use of one or more Ethernet Ports 321 to present an Ethernet Port having the IP address of the customer's network to the Internet 107 via an L2TP Network Server 303 in addition to the Ethernet Ports 322 having the IP address of the customer's network to connect to the Ethernet Switch 314 for internal IP traffic. The use of public IP addresses for both Ethernet Ports 321 and 322 open these ports to outside public access, since they do not reside behind any form of protection. In addition, this system uses customer IP addresses to serve internal IP needs.

Thus, all of the above-noted present system configurations suffer from one or more disadvantages, either the use of additional hardware or a simple inexpensive system with the loss of protection afforded by the use of the additional hardware.

Network Address Translation

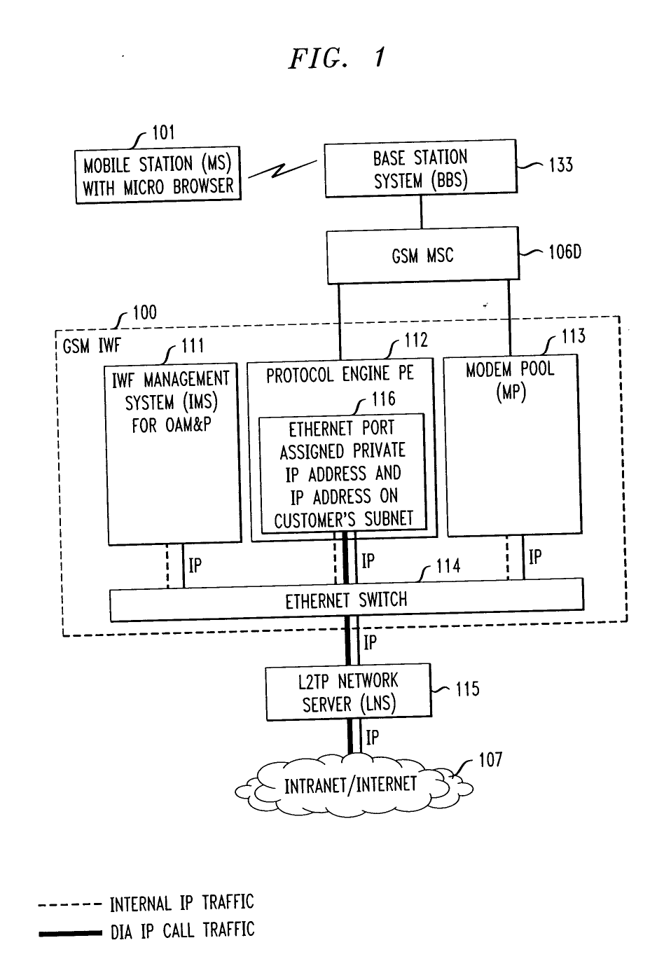

FIG. 1 illustrates in block diagram form the overall architecture of the present network address translation system that isolates internal IP traffic from external IP traffic in the Inter-Working Function (IWF) of a Global System for Mobile Communications network and an environment in which it is operational. In particular, the Inter-Working Function (IWF) 100 includes an Ethernet Switch 114 that interconnects the Inter-Working Function Management System 111, used for Operations, Administration, Maintenance & Provisioning functions, with the Inter-Working Function Protocol Engine 112 and a modem pool 113.

The Inter-Working Function Protocol Engine 112 includes one or more Ethernet Ports 116, each of which is assigned a private IP address, to connect to the Ethernet Switch 114 as well as a public IP address of the customer's network, used to connect to L2TP Network Server 115. Thus, customer data as shown by the heavy solid line on FIG. 1, received from the Mobile Subscriber Station 101 is passed from the GSM Mobile Switching Controller 106D to the Inter-Working Function Protocol Engine 112, where it is switched through one or more Ethernet Ports 116 to Ethernet Switch 114 and then to the L2TP Network Server 115 for transmission to the Internet 107.

Internal IP traffic, shown by the dotted line in FIG. 1, is transmitted through the Ethernet Switch 114 among the Inter-Working Function Management System 111, used for Operations, Administration, Maintenance & Provisioning functions, modem pool 113, and the Inter-Working Function Protocol Engine 112, using the private IP address assigned to one or more Ethernet Ports 116 of Inter-Working Function Protocol Engine 112.

Thus, the system of FIG. 1 provides dual IP addresses for the Ethernet Port 116, one having the IP address of the customer's network and one being the internal IP address active on the Ethernet Switch 114.

### SUMMARY

The p resent network address translation system isolates internal IP traffic from external IP traffic in the Inter-Working Function (IWF) of a Global System for Mobile Communications network by assigning dual IP addresses for the Inter-Working Function Protocol Engine.

1. A network address translation system for isolating internal IP traffic from external IP traffic in the Inter-Working Function of a Global System for Mobile Communications network, comprising:
network means for interconnecting an Inter-Working Function Protocol Engine and an Inter-Working Function Management System, located in said Inter-Working Function;
internal IP address means for assigning a port of said Inter-Working Function Protocol Engine with a private IP address for use exclusively on said network means;
external IP address means for assigning said port of said Inter-Working Function Protocol Engine with a public IP address for access from a source located external to said Inter-Working Function; and
routing means for assigning a one of said private and public IP addresses to data transmissions received at said network means and associated with said port of said Inter-Working Function Protocol Engine.

2. The network address translation system of claim 1 further comprising:
L2TP network server means connected to said network means for interconnecting said network means with the Internet.

3. The network address translation system of claim 2 wherein said routing means comprises:
address means for appending said assigned public IP address to said data transmission as a source address when said port of said Inter-Working Function Protocol Engine is a source of said data transmissions for transmission to said L2TP network server means.

4. The network address translation system of claim 3 wherein said routing means comprises:
address means for appending said assigned private IP address to said data transmission as a destination address when said port of said Inter-Working Function Protocol Engine is a source of said data transmissions for transmission to said Inter-Working Function Management System.

5. A method using network address translation for isolating internal IP traffic from external IP traffic in the Inter-Working Function of a Global System for Mobile Communications network, comprising:
interconnecting via a network an Inter-Working Function Protocol Engine and an Inter-Working Function Management System, located in said Inter-Working Function;
assigning a port of said Inter-Working Function Protocol Engine with a private IP address for use exclusively on said network;
assigning said port of said Inter-Working Function Protocol Engine with a public IP address for access from a source located external to said Inter-Working Function; and
assigning a one of said private and public IP addresses to data transmissions received at said network and associated with said port of said Inter-Working Function Protocol Engine.

6. The method of claim 5 further comprising:
interconnecting said network with the Internet via a L2TP network server connected to said network.

7. The method of claim 6 wherein said step of assigning a one of said private and public IP addresses to data transmissions received at said network comprises:
appending said assigned public IP address to said data transmission as a source address when said port of said Inter-Working Function Protocol Engine is a source of said data transmissions for transmission to said L2TP network server.

8. The method of claim 7 wherein said step of assigning a one of said private and public IP addresses to data transmissions received at said network comprises:
appending said assigned private IP address to said data transmission as a destination address when said port of said Inter-Working Function Protocol Engine is a source of said data transmissions for transmission to said Inter-Working Function Management System.
